(19) United States
(12) Patent Application Publication
(10) Pub. No.: US 2007/0269030 A1
(43) Pub. Date: Nov. 22, 2007

(54) Multimedia caller ID a system and method for presenting media at the time of an incoming call

(76) Inventor: Meir Shani, Tel-Aviv (IL)

Correspondence Address: Meir Shani, 45 Drezner, Tel-Aviv, 69497, omitted

(21) Appl. No.: 11/495,700

(22) Filed: Jul. 31, 2006

Related U.S. Application Data
(60) Provisional application No. 60/802,306, filed on May 22, 2006.

(51) Int. Cl. H04M 15/06; H04M 1/56

(52) U.S. Cl. 379/142.01

(57) ABSTRACT

The Multimedia Caller ID is a system and method for the delivery and presentation of media such as; images, animation and video to a conversation device (landline or wireless phone) at the time of an incoming call (ring/vibrate). This method includes the ability to present the caller ID information together with the media at the time of incoming call. One use of this invention among others is the creation of a new platform for promotion and advertisement over a variety of conversation devices, such as colored screen mobile and wired phones, DECT phones, IP telephony devices, etc.

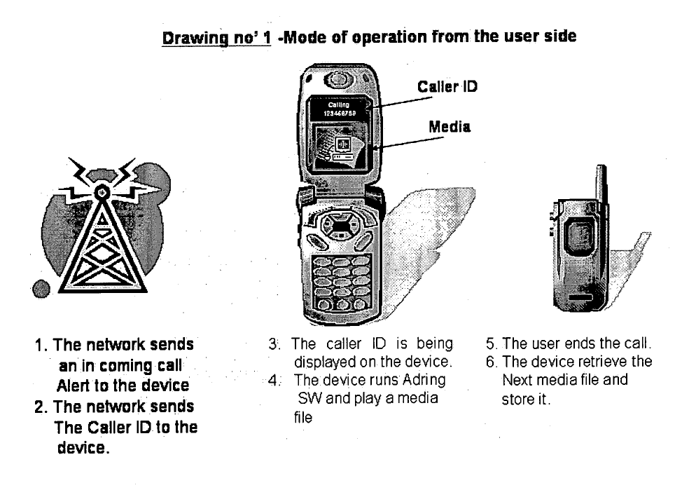

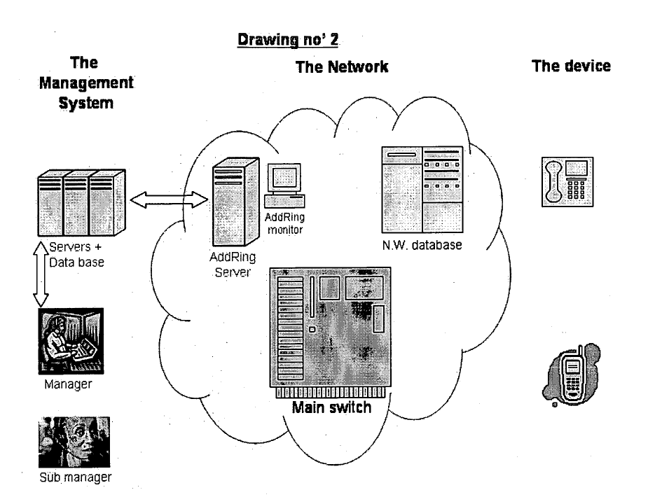

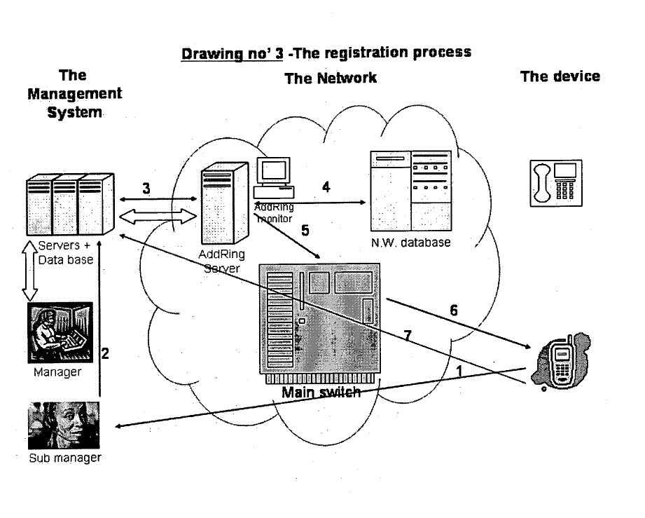

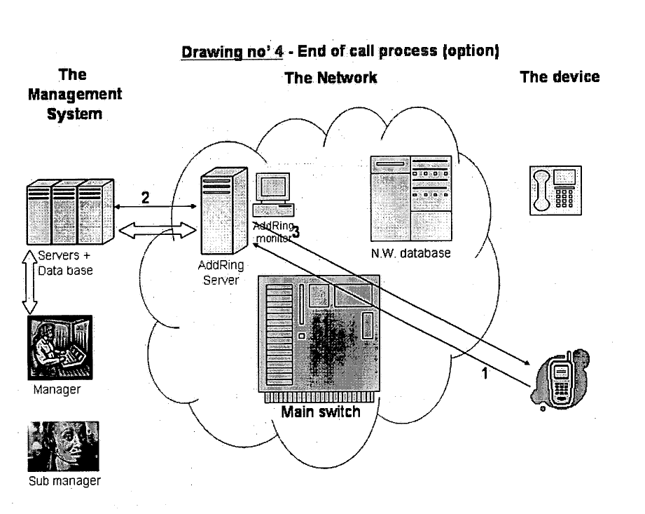

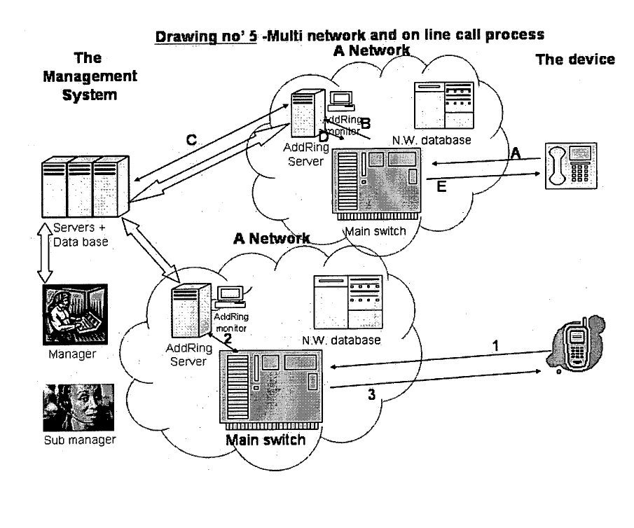

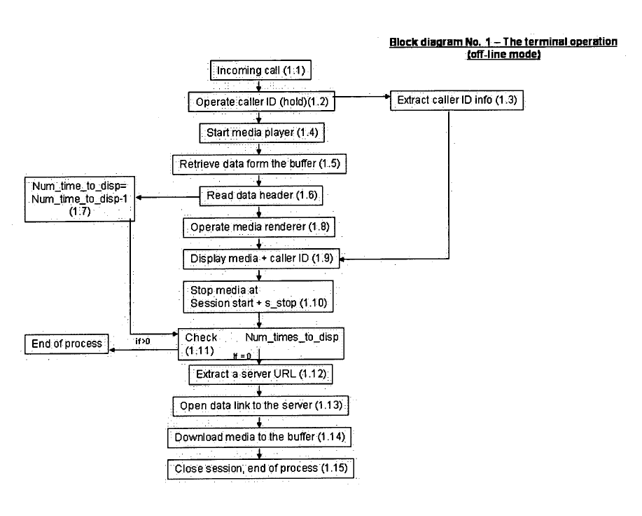

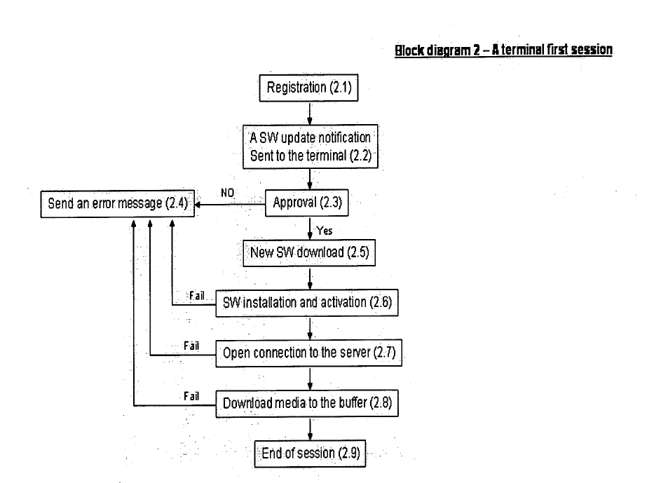

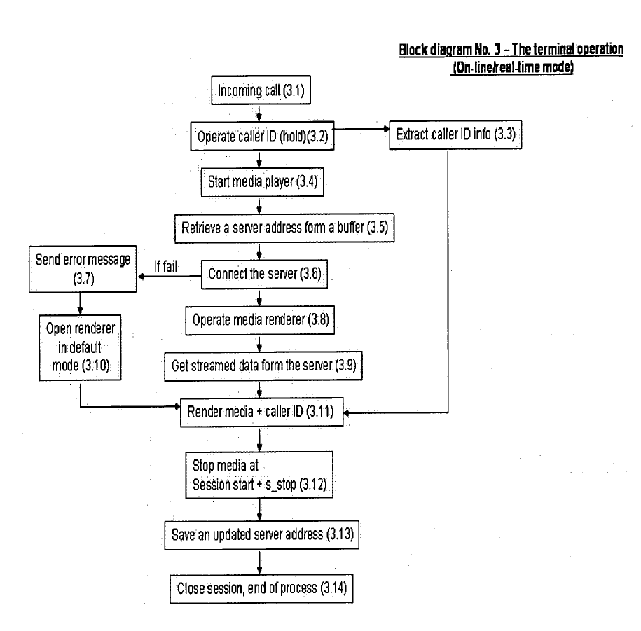

### BACKGROUND OF INNOVATION

With the introduction of a new line of digital telephony devices that contain large colored screens and functionalities that did not exist in traditional telephony devices, one of the most popular functions being used is the Caller ID. This function allows the recipient of a telephone call to identify the call originator before answering.

The logic behind the Multimedia Caller ID is the use of the caller ID function for additional purposes in parallel to the identification of the originator.

Since a brief look at the caller ID before answering has become the natural way many users answer a call, any information that appears at the time of the ring will have be seen by the user.

The information that can be added to the Caller ID is limited in space and time, but is very focused, targeted to a known recipient. This invention can be used in a variety of applications, among them targeted advertisements and promotion.

In this claim we describe a method and a system that pushes and displays a multimedia caller ID to the recipient terminal at the time of incoming call (along with a ring/vibrate). We explain this invention by using the Multimedia Caller ID for promotions and advertisements, although. the system can be used for other applications. We call this system AdRing.

### SUMMARY OF THE INVENTION

The AdRing system consists of a main server, a management system and a software module which is uploaded into the terminal device (phone). The main server is situated in the switchboard and controlled by the management system. The terminal of a user who registers for the multimedia caller ID function will automatically get a software update.

At the time of incoming call, the caller ID function will operate a media player that will combine the media content and the caller ID information. This media will be displayed on the recipient's screen.

Delivery of the media to the terminal will be done via a download (off-line) or a streaming (on-line) operation.

At the end of the session (end of call) the software will open a connection to the server in order to get the relevant multimedia information for the next incoming call. Since one purpose of this invention is advertisements, the end user will not have the ability to change the multimedia caller ID presentation. In this application, the multimedia caller ID will not be stored on the device. Alternatively, a multimedia presentation that is being promoted by the operator may be stored on the device and can be activated/modified by the terminal owner. The ADRING system can support multiple levels of service. Each level determines the services that the user wishes to receive and the types of service that the operator can transmit to his device.

### DETAILED DESCRIPTION

### Terminology

### Buffer—dynamic size memory allocated in the device memory.

### Device—the device that the end user operates (Such as a mobile phone, cordless phone, video conference device and more)

### Lib—libraries that carry information, such as pictures, ring tones, videos, mails etc.).

### Media—audio, image, clip art, animation, video, ring tones, etc.

### Rendering—The process of presenting the media data to the device's display

### Media player SW—The software installed in the device enabling ADRING operations.

### Decoding—The process of converting the data (analog or digital) to text, audio or visual forms.

### ADRING

4 main components,
1. The software installed on the terminal device
2. The media file
3. The server at the telephony network
4. The management system

### The Terminal

In the terminal device, a portion of its memory will be designated for media data (i.e. “buffer”). The special software module installed on the terminal will direct the buffer at the time of ring (incoming call).

During the normal process of an incoming call to the device, a signal is forwarded from the telephony switchboard to the phone using its control signals. These signals trigger the following commands as stored in the devices library:
1. Alert command: light up the display screen, set up voice or video ports
2. Incoming call command: operate a ring or vibration
3. Decode the caller ID and will store it.

4. Search for the caller ID details within the internal device memory and/or the SIM memory.
5. Render the caller ID details on the device display.

In an ADRING enabled terminal, in parallel to the caller ID decoding process, the device will operate a software media player that will use the media data stored in the buffer. The media player will be triggered by the caller ID decoding process and will retrieve the media data from the buffer and render it onto the display. In cases where the media data is a visual element, it will re-scale its size, if needed, to fit the screen according to the terminal display characteristics.

Information regarding the rendering process (such as time and exposure of media data) will be stored in the media header and operated by the media player (see the Media File).

Upon termination of the call, an IP session between the server and the device will be opened according to an address residing in the last media header. A download session will start to download new media to be saved in the buffer.

Alternatively, new media data may be streamed to the device, in real time, at the time of the end of the call or at the time of “incoming call” (beginning of a session.)

### The Media File:

This paragraph describes the types of media and a list of functions, operations and commands that are downloaded as the media file from the server to the device buffer.
1. Types of media:
   a. Ring tone
   b. Audio
   c. Visual image
   d. Clip art
   e. Animation
   f. Video
   g. Pointer to the internal device ring option.
   h. Any combination of the mentioned above.
2. Rendering time:
   a. Next incoming call
   b. After x incoming calls
   c. Load x second after the first ring
3. Duration of appearance
   a. Will be rendered for x seconds
   b. Will not be rendered before HH:MM DD/MM/YY
   c. Number of appearances (in each incoming call)
4. Click on function (for interactive banners)
   a. Target URL (will be open by a browser)
5. Load next (the next media buffer)
   a. URL

### Management System

The Management System is the heart of ADRING and offers complete control over all aspects of the application, including user registration, operation, definitions, tracking and status, etc.

The Management System is capable of controlling multiple ADRING servers in the network, whether they are all located in a single location or placed in several locations. All the media files intended for the terminal devices are also controlled by the management system.

The management system may be operated by the system administrator and other system managers, using various levels of permissions.

The functionality of the management systems include:
1. Registration of a device to a service
2. Definition of the service
3. Operation of the service
4. Controlling of the service
5. Statistic reports
6. Billing reports
7. Status reports
8. Alarms
9. Capacity and peak control and reports
10. Access/operation of each server (in the network) and full control of it remotely.
11. Back up management
12. Data base management
13. Upload and removal of media
14. Media rules (validation, time to display act.)
15. Rules of exposure and use on a user base.

### The ADRING Server System and the Telephony Network

In this chapter we describe how the ADRING server system interfaces with the telephony network.

The server resides as part of the telephony network (wired (SATN), cellular, VoIP or cable TV based telephony). It is connected to the network using the following connections.
a. A connection to the internal network protocol, such as the SSx, SIP, Docsis, H.323 protocols of the network.
b. A connection to the roaming (HLR, VLR in a cellular network) or similar systems.
c. A connection to the network billing system.
d. A connection to the users and devices data base of the network
e. A connection to the network management system (using SNMP or alike).

The server will also be connected to:
f. Local and remote data bases of media
g. The global internet network.
h. The management system

Each server will store all the media and control the transmission of media to all the devices in its' area. The server will be equipped to manage its load in order to avoid a network overload by directing the management system in a timely manner to forward the control of certain users to another available server. Servers will be able to “negotiate” with other servers in its network (to be pre-configured).

Although as previously stated the servers will be controlled by the management system, every server will have the ability to work independently if the management system is not connected (automatic mode). A server will be capable of taking over a server that is out of order.

The servers will operate a local and remote database.

### Mode of Operation

As a way of explanation, this chapter describes one possible mode of operation.

In an ADRING enabled network, a user holding a suitable device registers for the service. Registration can be done through various methods, such as:
1. The Web
2. WAP
3. Customer support
4. SMS or MMS

The user is registered in the data base of the management system and includes all the necessary information for provision of the service, such as device ID, service level, billing information ect'. The data of the user is retrieved from the network database and a user profile is built.

At this time, the user's device gets an automatic SW update. The device then activates the SW and notifies the management system that it is ready to begin service. A session between the device and the server is opened and the very first media to the device buffer is downloaded.

An incoming call on the device activates the media player SW and renders the media as described previously.

At the end of the call, the device connects to the server to get the next media. Alternatively it will hold an address of the next media that will be retrieve on-line (streaming) at the time of its next incoming call.

### DRAWINGS

### Drawing No' 1—The End User

This drawing describes the image that appears on the device as a result of ADRING operation.
1. The network transmits to the device an incoming call alert and simultaneously transmits the caller ID.
2. In on line system the device opens a data port to the network and the network opens a session with the media player
3. The incoming alert or the Caller ID function operates the ADRING SW and activates the media player in the device.
4. In off line systems, the media player opens the media file residing in the buffer. In on line systems, the media player retrieves the media data from the network and displays it on the device.
5. In off line systems, at the end of the call, the device opens a data port according to a pre defined URL to the media server and downloads the next media file to the device.
6. In on line systems, the device stores a new URL addressing the next media file.

### Drawing No' 2—The Network

This drawing displays the location of the ADRING servers in the network.

The ADRING servers are an integral part of the network, but the management system is located and operated externally to the network.

Media servers exist both as part and separated from the network.

### Drawing No' 3—The Registration Process

This drawing describes the process of a new registration to the service as seen by the network.
1. The user calls a call center or the customer support operator (alternately, this can be done using WAP, the internet or other ways).
2. The call center registers the user on the main server of ADRING.
3. the ADRING main server registers the user to its local server (located in the network)
4. The local ADRING server retrieves information about the user from the network user's database.
5. Through the Main Switch, the ADRING server sends the media player software to the device, and installs it. (6).
7. The device sends an acknowledgement signal via the network to the main server that the registration and software installation has succeeded.

### Drawing 4—End of Call Process (in Off Line Systems)

1. At the end of the call the device open a data port to the server according to a URL that is located in the header of the media file.
2. The network server downloads new media to the device,
3. The network server transmits the media file to the device.

### Drawing 5—Multi Network and on Line Process

The scope of this drawing is to show that the same system can work on PSTN and cellular networks simultaneously.

The management of a multi network is needed in cases where:

### I. More then one network server is located in one Main Switch area (for capacity and redundancy).

### II. A single main server controls a variety of local network servers, each located near a main switch.

### III. A variety of operators that operates many main switches.

### PSTN Media Delivery (A.D):

On line process (at the time of an in coming call)

A. The device opens a data port to the switchboard.

B. The switchboard notifies the server that it has an open port to the user.

C. The NW server retrieves media from the main server (if needed).

D. The NW server starts to stream the data via the switchboard (E) to the device.

### Cellular Media delivery (1.3):

On line process; (at the time of in coming call)

This happened when no data is needed from the main server or in case that the connection to the main server is not available.
1. The device opens a data port to the NW server via the switchboard.
2. The NW server identifies the user and streams data via the switchboard (3) to the device.

### Block Diagrams:

### Block Diagrams No' 1

Diagram 1—this diagram explains an off line method that can be used in order to present a media data over a terminal screen (cell phone) at the time of alert (incoming call) in this example we are using a telephone system method as follows: an incoming call signal is being transmitted from the operator (switch) to the terminal (1.1) simultaneously as part of this operation a caller ID signal is being transmitted, this signal operates the caller ID decoder at the terminal side (1.2), this operation will be held (delayed) in order to avoid the presentation of the caller ID while saving the caller ID in the terminal memory (1.3). The operation of the caller ID function will trigger/operate the media player function (1.4) that is installed on the terminal. The media player will retrieve data from a predefined memory buffer (1.5), rules to activate the media reside in the media header (1.6) among those are rules regarding the number of times to replay, meaning that the buffer will not updated of pre defined cycles, this operation will reduce 1 cycle and will update the buffer accordingly (1.7), the media player will operate/trigger the display rendered (1.8) and will display the media including the caller ID as an overlay. (1.9). The media will be displayed as long as the incoming call signal is valid; at the time of session-start the media player will clear the display, (1.10). in case that the current cycle is not the last one, the operation will stop and be set in to a standby mode waiting for the next incoming call signal (EOP). In case that the media buffer should be updated, a destination server URL will be extracted, (1.11) and will open a data link with this server (1.12). a download of a new media will be transferred (1.13). At the end of the download process the old media in the buffer will be deleted. A session termination (of the data link) will end the operation of the system (1.15). A standby mode will be set waiting for the next incoming call signal.

### Block Diagram No' 2

In block diagram no 2 we will demonstrate the way the system is registering a new user. Note that it refers to the terminal and not to the management system or data base.

A new user is being registered to the service (2.1), this can be done in a variety of methods among them: 1. registration via the web or 2. WAP, 3. by using a call center and others methods that are out of the scope of this diagram. The systems according to the registered information will send a notification to the user, i.e. “a new software is about to be downloaded please approve” (2.2). Upon approval, dedicated software will be downloaded to the user terminal (2.3). In case that the download didn't succeed an error massage will be displayed and a notification will be sent to the remote application (call center of such) (2.4). In case of approval the SW will be download to the terminal (2.5) at the end of the download the terminal will automatically install and will activate the application (2.6). The first act to be performed is—the application will connect a dedicated server and will notify about a successful installation (2.7). Following—it will download its first media (to be played) from a dedicated link that will be sent by the server (2.8). At the completion of the media download the application will be set to standby mode, awaiting for an incoming call signal to trigger it (2.9).

### Block Diagram No' 3

In this diagram is an explanation on the on-line method for the delivery of media to the terminal at the time of an incoming call. Upon an incoming call signal to the terminal (3.1) the “regular” operation of transferring the caller ID function is changed (3.2) and it will be sent to a temporary buffer (3.3) instead of the standard procedure of Call ID presentation, a media player will be operated by the device (3.4) the player will find a server address (3.5) in its buffer (an updated buffer) and will operate an IP data session accordingly (3.6), In case that this session fails (3.7) an error massage will be sent to the server and the operation will proceed using a default media that exists in the terminal (3.10). In case that the session with the server has been operated successfully (3.6), the media player will run a display renderer (3.8) while a streaming session between the server and the media player is being established. For the presentation of the media and the caller ID the renderer will over lay the caller ID over the media according to predefined parameters that exist on the media header (3.11). At the end of the incoming call or at the beginning of the voice/video session the media presentation will stop (3.12). The terminal will retrieve and will save an updated server address (to be use in the next incoming call session) (3.13). The data link with the server will be terminated, operation end successfully (3.14)

1. A method for displaying a media presentation on the telephone's screen simultaneously with the ring, alerting the user to an incoming call.

2. The method of claim 1 where the media is displayed for a predefined, limited time.

3. The method of claim 1 where the user can not control the media presentation.

4. The method of claim 1 includes the ability of a user to alert one or more other users.

5. A method of claim 1 where an add on software module loaded in the device is activated by the alert signal.

6. The method of claim 5 where the add on module is operated by the caller ID module.

7. A method of acknowledging the media reception by the user.

8. The method of claim 7 where the user get a temporary media data from a server.

9. The method of claim 7 which includes the ability of the server to identify the user.

10. The method of claim 8 where the server has the ability to identify the end of a call session between users.

11. A method to deliver media data to a receiving device upon the end a session (hang up).

12. A method of transferring media to a device in parallel to the alert signal.

13. A method of integration between the media and the caller ID

14. The method of claim 13 where the caller ID can be a part of the media.

15. The method of claim 13 where the caller ID can be displayed in parallel to the media.
